(19) United States
(12) Patent Application Publication
(10) Pub. No.: US 2009/0194190 A1
(43) Pub. Date: Aug. 6, 2009

(54) Variable switch point for a cascade storage system for gaseous Hydrogen

(75) Inventors: Daniel Glenn Casey, Kingwood, TX (US); Brandon W. Janak, Katy, TX (US); Kent Alan DeBoer, Berkeley, CA (US)

Correspondence Address: CHEVRON SERVICES COMPANY;LAW, INTELLECTUAL PROPERTY GROUP, P.O. BOX 4368, HOUSTON, TX, 77210-4368, US

(73) Assignee: Texaco Inc., San Ramon, CA (US)

(21) Appl. No.: 12/331,187

(22) Filed: Dec. 9, 2008

Related U.S. Application Data
(60) Provisional application No. 61/013,798, filed on Dec. 14, 2007.

(51) Int. Cl. F17C 5/00

(52) U.S. Cl. 141/4

(57) ABSTRACT

In the present invention, a cascade storage system for gaseous hydrogen including a variable switch point is disclosed. The variable switch point allows the cascade storage system to quickly dispense gaseous hydrogen to fill hydrogen vehicles in addition to increasing the utilization of gaseous hydrogen in the cascade storage system.

Priority of U.S. Provisional Patent Application No. 61/013,798, filed Dec. 14, 2007, is claimed under 35 U.S.C. § 119.

### FIELD OF THE INVENTION

The present invention relates generally to a cascade storage system for gaseous hydrogen and in particular to a variable switch point for a cascade storage system for gaseous hydrogen.

### BACKGROUND OF THE INVENTION

Hydrogen is utilized in a wide variety of industries ranging from aerospace to food production to oil and gas production and refining. Hydrogen is used in these industries as a propellant, an atmosphere, a carrier gas, a diluents gas, a fuel component for combustion reactions, a fuel for fuel cells, as well as a reducing agent in numerous chemical reactions and processes. In addition, hydrogen is being considered as an alternative fuel for power generation because it is renewable, abundant, efficient, and unlike other alternatives, produces zero emissions. While there is wide-spread consumption of hydrogen and great potential for even more, a disadvantage which inhibits further increases in hydrogen consumption is the absence of a hydrogen infrastructure to provide widespread generation, storage and distribution.

One way to overcome this difficulty is through the operation of hydrogen energy stations. At hydrogen energy stations, hydrogen generators such as reformers or electrolyzers are used to convert hydrocarbons or water to a hydrogen rich gas stream. Current art uses multi-step processes combining an initial conversion process with several clean-up processes. The clean-up process can include treating the hydrocarbon rich stream by pressure swing adsorption to create a high purity hydrogen gas. Alternative processes for recovering a purified hydrogen gas include the use of hydrogen selective membrane reactors and filters.

The gaseous hydrogen is then stored in stationary storage vessels at the hydrogen energy stations to provide inventory to fuel hydrogen vehicles such as hydrogen cars and hydrogen buses. A cascade storage system is often used in the industry for dispensing gaseous hydrogen at hydrogen energy stations. The cascade storage system is divided into several storage banks of storage vessels. Several storage vessels with the same storage pressure are typically inter-connected to form one storage bank. In addition, several storage banks at different storage pressures are interconnected to form the cascade storage system. Typically between one and six storage vessels make up a storage bank. Typically between three and nine storage banks are used in a cascade storage system.

When a hydrogen vehicle needs to be fueled with gaseous hydrogen, the valve between the first storage bank and the dispenser is opened. This valve can be an on/off type of valve such as a ball valve. When this valve is opened, the pressure of the first storage bank and the vehicle tank will equalize. During equalization, gaseous hydrogen flows between the first storage bank and the vehicle tank. Once the first storage tank and the vehicle tank equalize and the differential pressure is zero the flow of gaseous hydrogen will stop and the valve will close. The pressure differential will be the greatest when the valve is first opened and will follow a logarithmic decay until it reaches a differential pressure of zero. The maximum flow will be based on the physical properties of the gaseous hydrogen, the starting pressure, and the pressure drop in the piping including the on/off valve. The valve (or an associated restricting orifice) can be characterized by a flow coefficient (Cv).

Next, the valve between the second storage bank and the dispenser is opened. When this valve is opened, the pressure of the second storage bank and the vehicle tank will equalize. During equalization, gaseous hydrogen flows between the second storage bank and the vehicle tank. This process will continue until the vehicle tank is filled with gaseous hydrogen. The nominal pressure of the filled vehicle tank can be 5076 psig (350 bar).

The point at which the transfer is made from storage bank to storage bank can be called the switch point. The current state of the art measures either the differential pressure or the flow between the storage bank and the vehicle tank. Due to the extended time required for the logarithmic decay to reach a differential pressure of zero, the cascade storage system will switch at some point before zero differential pressure or zero flow is reached. This switch point is typically a fixed point such as 50 psi or 0.05 kg/min. Having a higher switch point allows for faster filling times of hydrogen vehicles. Having a lower switch point allows for greater utilization of the gaseous hydrogen in the cascade storage system.

The present invention addresses both the desire to quickly dispense gaseous hydrogen to fill hydrogen vehicles and to increase the utilization of gaseous hydrogen in the cascade storage system by providing a variable switch point.

### SUMMARY OF THE INVENTION

In the present invention, a cascade storage system for gaseous hydrogen including a variable switch point is disclosed. The variable switch point allows the cascade storage system to quickly dispense gaseous hydrogen to fill hydrogen vehicles in addition to increasing the utilization of gaseous hydrogen in the cascade storage system.

A hydrogen energy station generates, stores, and distributes gaseous hydrogen to hydrogen vehicles, such as hydrogen cars and hydrogen buses, or other devices requiring a gaseous hydrogen feed. The hydrogen energy station stores gaseous hydrogen in stationary storage vessels to provide inventory to fuel hydrogen vehicles. One embodiment of a hydrogen energy station of the present invention utilizes a cascade storage system. The cascade storage system includes a number of storage vessels within a number of storage banks. The switch point transfers the flow of gaseous hydrogen from one storage bank to another storage bank.

The variable switch point of the present invention optimizes the flow rate of gaseous hydrogen in the cascade storage system. Instead of being a fixed point, the variable switch point of the present invention is a function of the quantity or percentage of gaseous hydrogen in the cascade storage system.

### BRIEF DESCRIPTION OF THE FIGURES

The description is presented with reference to the accompanying figures in which:

FIG. 1 shows a typical fill from a cascade storage system to a vehicle tank of a hydrogen vehicle at a demonstration hydrogen energy station in California, with a fixed switch point of 0.05 kg/min flow of hydrogen.

FIG. 2 shows a typical fill from a cascade storage system to a vehicle tank of a hydrogen vehicle at a demonstration hydrogen energy station in California, with a fixed switch point of 0.97 kg/min flow of hydrogen.

FIG. 3 shows a typical fill from a cascade storage system to a vehicle tank of a hydrogen vehicle at a demonstration hydrogen energy station in California, with a fixed switch point of 0.2 kg/min flow of hydrogen.

FIG. 4 shows a typical fill from a cascade storage system to a vehicle tank of a hydrogen vehicle at a demonstration hydrogen energy station in California, with a fixed switch point of 1.00 kg/min flow of hydrogen.

FIG. 5 shows a typical fill from a cascade storage system to a vehicle tank of a hydrogen vehicle at a demonstration hydrogen energy station in California, with a variable switch point.

FIG. 6 shows a typical fill from a cascade storage system to a vehicle tank of a hydrogen vehicle at a demonstration hydrogen energy station in Rosemead, Calif. without a variable switch point.

FIG. 7 shows a typical fill from a cascade storage system to a vehicle tank of a hydrogen vehicle at a demonstration hydrogen energy station in Rosemead, Calif. with a variable switch point.

### DETAILED DESCRIPTION OF THE INVENTION

The present invention discloses a variable switch point for a cascade storage system for gaseous hydrogen. The variable switch point of the present invention optimizes the flow rate of gaseous hydrogen in the cascade storage system.

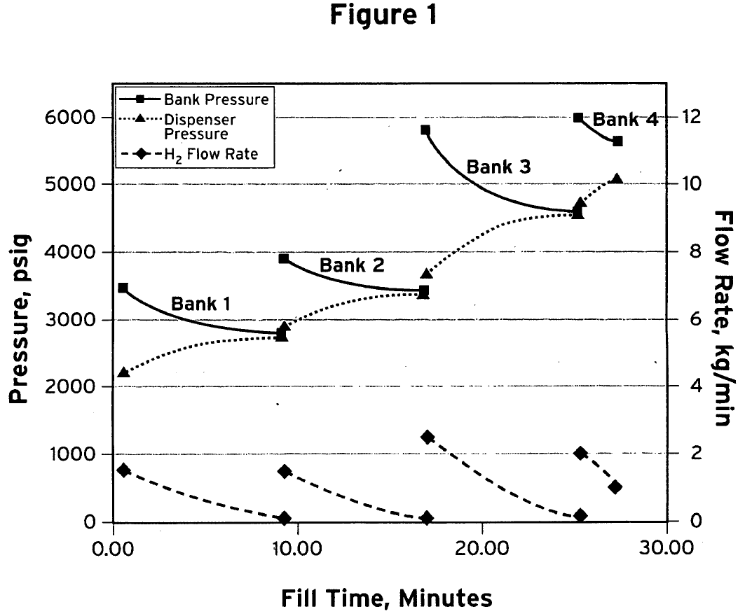

With reference to FIG. 1, FIG. 1 shows one example of a typical fill from a cascade storage system to a vehicle tank of a hydrogen vehicle at a demonstration hydrogen energy station in California, with a fixed switch point of 0.05 kg/min flow of hydrogen. This fill utilizes four storage banks of the cascade storage system.

As can be seen in FIG. 1, the fill rate (bottom line) begins at a peak value as each cascade storage bank valve opens and decreases as it approaches the switch point (0.05 kg/min in this example). The maximum flow for the first storage bank, storage bank 1, starts when there is the greatest differential pressure between the dispenser pressure (middle line) and the pressure in storage bank 1 (top line). As the dispenser pressure approaches the pressure of storage bank 1, the differential pressure and flow rate are reduced. When the flow rate reduces to 0.05 kg/min, the gaseous hydrogen supply is switched from storage bank 1 to the second storage bank, storage bank 2. The flow rate for storage bank 2 is at a maximum when the differential pressure is greatest and reduces to 0.05 kg/min before switching to the third storage bank, storage bank 3. For this fill, storage bank 3 has a higher starting pressure than storage banks 1 or 2. As a result, there is both a higher differential pressure and a higher flow rate to the vehicle tank. This process is repeated when the flow from storage bank 3 is reduced to 0.05 kg/min and flow is switched to the fourth storage bank, storage bank 4.

The values for starting differential pressure for each storage bank and the associated flow rate are shown in the following table:

| | Starting | | Starting | Starting | Minimum |
|---|---|---|---|---|---|
| | Storage | | Differential | Flow | Flow |
| Storage | Pressure | Dispenser | Pressure | Rate | Rate |
| Bank | psig | psig | psig | kg/min | kg/min |
| 1 | 3476 | 2233 | 1243 | 1.53 | 0.05 |
| 2 | 4007 | 2907 | 1100 | 1.47 | 0.05 |
| 3 | 5986 | 3918 | 2068 | 2.46 | 0.05 |
| 4 | 6106 | 4758 | 1348 | 1.91 | 1.2 |

As will be shown below, if the variable switch point of the present invention was used instead of the fixed switch point of 0.05 kg/min, the switch would have occurred sooner resulting in a shorter fill time and a higher overall average fill rate than the 0.88 kg/min average flow in this example.

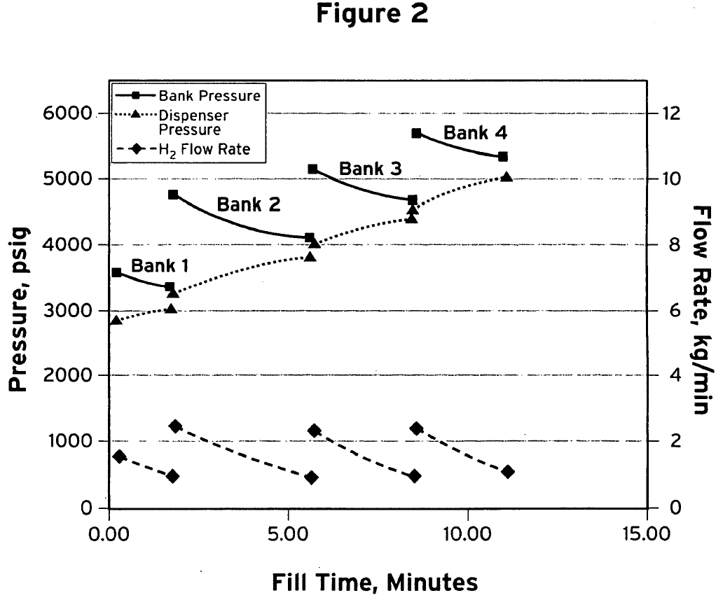

With reference to FIG. 2, FIG. 2 shows another example of a typical fill from a cascade storage system to a vehicle tank of a hydrogen vehicle at a demonstration hydrogen energy station in California, with a fixed switch point of 0.97 kg/min flow of hydrogen. This fill utilizes four storage banks of the cascade storage system.

As can be seen in FIG. 2, the fill rate (bottom line) begins with storage bank 1. When the valve to storage bank 1 is opened flow begins at a peak value and decreases as it approaches the switch point (0.97 kg/min in this example). The maximum flow for storage bank 1 starts when there is the greatest differential pressure between the dispenser pressure (middle line) and the pressure in storage bank 1 (top line). When the flow rate reduces to 0.97 kg/min, the gaseous hydrogen supply is switched from storage bank 1 to storage bank 2. This process is repeated for storage banks 3 and 4 until the vehicle tank is filled.

The values for starting differential pressure for each storage bank and the associated flow rate are shown in the following table:

| | Starting | | Starting | Starting | Minimum |
|---|---|---|---|---|---|
| | Storage | | Differential | Flow | Flow |
| Storage | Pressure | Dispenser | Pressure | Rate | Rate |
| Bank | psig | psig | Psig | kg/min | Kg/min |
| 1 | 3603 | 2843 | 760 | 1.56 | 0.97 |
| 2 | 4951 | 3293 | 1658 | 2.42 | 0.97 |
| 3 | 5495 | 4041 | 1454 | 2.26 | 0.97 |
| 4 | 6047 | 4613 | 1434 | 2.34 | 1.1 |

As will be shown below, if the variable switch point of the present invention was used instead of the fixed switch point of 0.97 kg/min, the switch would have occurred sooner resulting in a shorter fill time and a higher overall average fill rate.

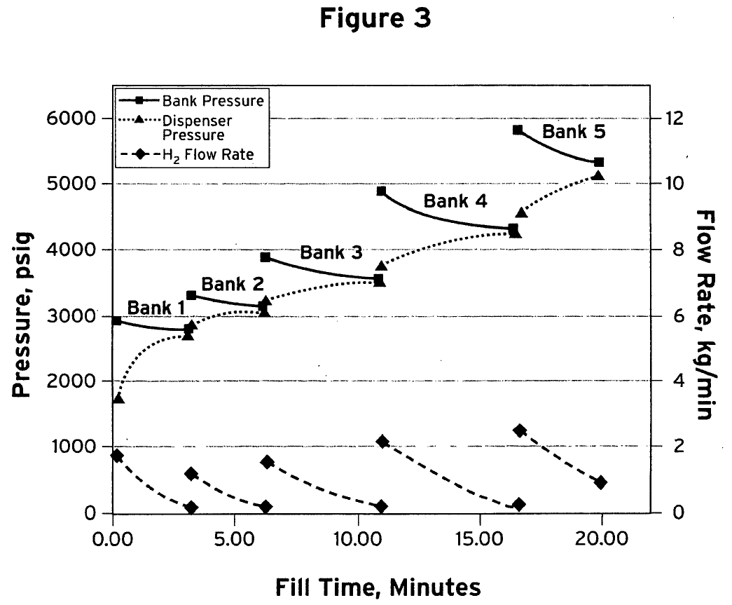

With reference to FIG. 3, FIG. 3 shows another example of a typical fill from a cascade storage system to a vehicle tank of a hydrogen vehicle at a demonstration hydrogen energy station in California, with a fixed switch point of 0.2 kg/min flow of hydrogen. This fill utilizes five storage banks of the cascade storage system.

As can be seen in FIG. 3, the fill rate (bottom line) begins with storage bank 1. When the valve to storage bank 1 is opened flow begins at a peak value and decreases as it approaches the switch point (0.2 kg/min in this example). The maximum flow for storage bank 1 starts when there is the greatest differential pressure between the dispenser pressure (middle line) and the pressure in storage bank 1 (top line). When the flow rate reduces to 0.2 kg/min, the gaseous hydrogen supply is switched from storage bank 1 to storage bank 2. This process is repeated for storage banks 3, 4, and 5 until the vehicle tank is filled.

The values for starting differential pressure for each storage bank and the associated flow rate are shown in the following table:

| | Starting | | Starting | Starting | Minimum |
|---|---|---|---|---|---|
| | Storage | | Differential | Flow | Flow |
| Storage | Pressure | Dispenser | Pressure | Rate | Rate |
| Bank | Psig | psig | Psig | kg/min | kg/min |
| 1 | 3058 | 1742 | 1316 | 1.7 | 0.2 |
| 2 | 3401 | 2865 | 536 | 1.2 | 0.2 |
| 3 | 4009 | 3246 | 763 | 1.5 | 0.2 |
| 4 | 5196 | 3807 | 1389 | 2.1 | 0.2 |
| 5 | 6170 | 4850 | 1320 | 2.5 | 0.9 |

As will be shown below, if the variable switch point of the present invention was used instead of the fixed switch point of 0.2 kg/min, the switch would have occurred sooner resulting in a shorter fill time and a higher overall average fill rate.

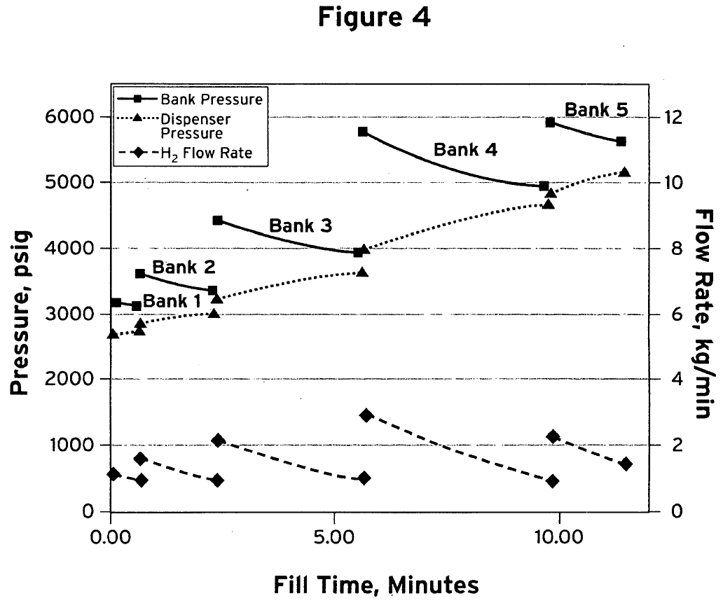

With reference to FIG. 4, FIG. 4 shows another example of a typical fill from a cascade storage system to a vehicle tank of a hydrogen vehicle at a demonstration hydrogen energy station in California, with a fixed switch point of 1.55 kg/min flow of hydrogen. This fill utilizes five storage banks of the cascade storage system.

As can be seen in FIG. 4, the fill rate (bottom line) begins with storage bank 1. When the valve to storage bank 1 is opened flow begins at a peak value and decreases as it approaches the switch point (1.00 kg/min in this example). The maximum flow for storage bank 1 starts when there is the greatest differential pressure between the dispenser pressure (middle line) and the pressure in storage bank 1 (top line). When the flow rate reduces to 1.00 kg/min, the gaseous hydrogen supply is switched from storage bank 1 to storage bank 2. This process is repeated for storage banks 3, 4, and 5 until the vehicle tank is filled,

The values for starting differential pressure for each storage bank and the associated flow rate are shown in the following table:

| | Starting | | Starting | Starting | Minimum |
|---|---|---|---|---|---|
| | Storage | | Differential | Flow | Flow |
| Storage | Pressure | Dispenser | Pressure | Rate | Rate |
| Bank | psig | psig | psig | kg/min | kg/min |
| 1 | 3166 | 2703 | 463 | 1.1 | 1.00 |
| 2 | 3617 | 2859 | 758 | 1.6 | 1.00 |
| 3 | 4419 | 3243 | 1176 | 2.1 | 1.00 |
| 4 | 5761 | 4008 | 1753 | 2.8 | 1.00 |
| 5 | 5910 | 4865 | 1045 | 2.3 | 1.48 |

As will be shown below, if the variable switch point of the present invention was used instead of the fixed switch point of 1.00 kg/min, the switch would have occurred sooner resulting in a shorter fill time and a higher overall average fill rate.

Instead of being a fixed point as in the above examples, the variable switch point of the present invention is a function of the quantity or percentage of gaseous hydrogen in the cascade storage system. This relationship is shown in the following equation written for the variable switch point (VSP):

VSP=(a*% Inventory−b)*V

In the above equation, the “% Inventory” equals the current mass of gaseous hydrogen in inventory in the cascade storage system divided by the maximum total possible mass of gaseous hydrogen in inventory in the cascade storage system (i.e. the capacity of the cascade storage system) multiplied by 100. In addition, “a” is a constant in the range of 0.000017 to 0.000034, preferably 0.000024 to 0.000026. Further, “b” is a constant in the range of −0.00095 to −0.0024, preferably −0.00142 to −0.00171. Finally, V equals the vehicle tank storage volume in liters. The above empirical equation for a variable switch point for a cascade storage system was developed from fill data from demonstration hydrogen energy stations.

The variable switch point of the present invention is universally applicable. It can be used for any station size including commercial stations (with storage capacity on the order of 1500 kilograms). The variable switch point of the present invention has been demonstrated with storage ranging from 64 to 360 kilograms of gaseous hydrogen. In addition, the variable switch point of the present invention can be used for any hydrogen vehicle including, but not limited to, hydrogen cars and hydrogen buses and has been demonstrated with volumes ranging from 152 to 2100 liters.

Using the above equation, for an example where the capacity of the cascade storage system is 360 kilograms and the vehicle volume is 2100 liters, when the current mass of gaseous hydrogen in the cascade storage system is 360 kilograms, the % Inventory is 100% which corresponds to a variable switch point of 2.4 kg/min. As shown in the below table, as the current mass of gaseous hydrogen in the cascade storage system decreases, the variable switch point also decreases.

| Current Mass | % Inventory | Variable Switch Point |
|---|---|---|
| (kg) | (%) | (kg/min) |
| 360 | 100 | 2.4 |
| 330 | 91.67 | 1.95 |
| 250 | 69.44 | 0.75 |
| 210 | 58.33 | 0.15 |

When the cascade storage system is at full capacity, a switch point over 2 kg/min will result in faster fueling of a 2100 liter hydrogen vehicle. However, if the switch point were over 2 kg/min when the cascade storage system was at low capacity, no flow would occur because there would not be enough differential pressure to provide that flow. In this scenario, a switch from a low pressure storage bank to the next highest pressure storage bank would occur without any flow occurring for that storage bank which would result in low gaseous hydrogen utilization. In addition, it could also result in a vehicle not being completely filled while at the dispensing station. Therefore, in order to provide fast filling of hydrogen vehicles and maintain a high utilization rate, the switch point must be adjusted based on the capacity of the cascade storage system as demonstrated by the variable switch point of the present invention.

In another embodiment, the variable switch point can be further limited to operate with in the range of not less than 0.05 kg/min and not greater than 2.0 kg/min. This range limit prevents operation at extreme high or low values as calculated by the equation.

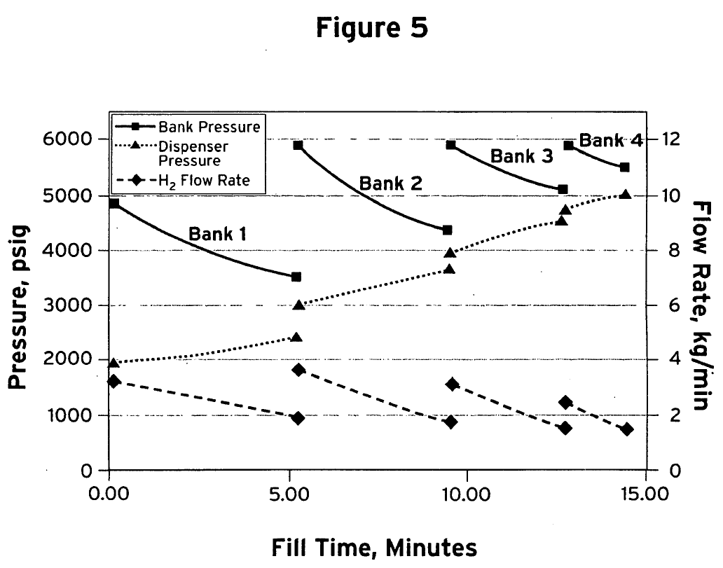

With reference to FIG. 5, FIG. 5 shows an embodiment of a typical fill from a cascade storage system to a 2100 liter vehicle tank of a hydrogen vehicle at a demonstration hydrogen energy station in California, with the variable switch point of the present invention. This fill utilizes four storage banks of the cascade storage system.

As can be seen in FIG. 5, the fill rate (bottom line) begins with storage bank 1. When the valve to storage bank 1 is opened flow begins at a peak value and decreases as it approaches the variable switch point (1.86 kg/min in this example). When the valve to storage bank 2 is opened flow begins at a peak value and decreases as it approaches the variable switch point (1.69 kg/min in this example). The variable switch point reduces as the storage inventory is used for the fill. When the valve to storage bank 3 is opened flow begins at a peak value and decreases as it approaches the variable switch point (1.54 kg/min in this example). The variable switch point is further reduced as the storage inventory is used for the fill. When the valve to storage bank 4 is opened flow begins at a peak value and decreases as it approaches the variable switch point (1.49 kg/min in this example). The variable switch point is further reduced as the storage inventory is used to complete the fill.

The values for starting differential pressure for each storage bank and the associated flow rate are shown in the following table:

| | Starting | | Starting | Starting | Minimum |
|---|---|---|---|---|---|
| | Storage | | Differential | Flow | Flow |
| Storage | Pressure | Dispenser | Pressure | Rate | Rate |
| Bank | psig | psig | psig | kg/min | kg/min |
| 1 | 5171 | 1944 | 3227 | 3.2 | 1.86 |
| 2 | 6243 | 2996 | 3247 | 3.6 | 1.69 |
| 3 | 6154 | 3975 | 2179 | 3.1 | 1.54 |
| 4 | 6249 | 4729 | 1520 | 2.4 | 1.49 |

The average fill rate for the fill shown in FIG. 5 was 2.39 kg/min. This is a marked improvement compared to the fill in FIG. 1 which had an average overall fill rate of 0.88 kg/min. The variable switch point of the present invention optimizes the flow rate of gaseous hydrogen in the cascade storage system.

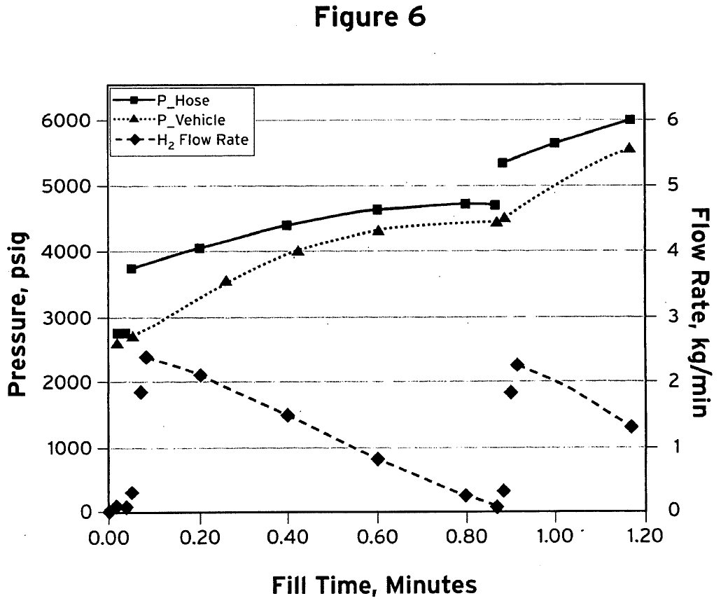

With reference to FIG. 6, FIG. 6 shows an embodiment of a typical fill from a cascade storage system to a 152 liter vehicle tank of a hydrogen vehicle at a second demonstration hydrogen energy station in California, without the variable switch point of the present invention. This fill utilizes two storage banks of the cascade storage system.

As can be seen in FIG. 6, the fill rate (bottom line) begins with storage bank 1. When the valve to storage bank 1 is opened flow begins at a peak value and decreases as it approaches the standard switch point (0.05 kg/min in this example). When the valve to storage bank 2 is opened flow begins at a peak value and decreases till the end of the fill (1.26 kg/min in this example).

The average fill rate for the fill shown in FIG. 6 was 1.5 kg/min. This is the baseline for flow rate of gaseous hydrogen in this second cascade storage system.

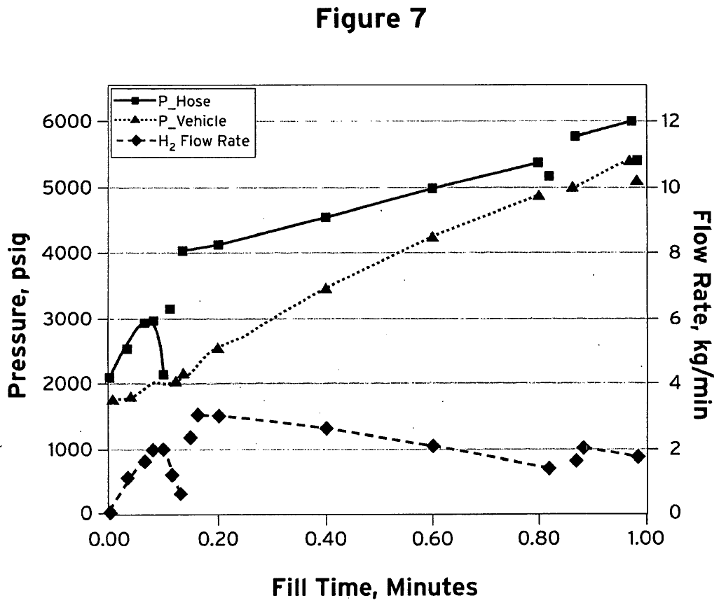

With reference to FIG. 7, FIG. 7 shows an embodiment of a typical fill from a cascade storage system to a 152 liter vehicle tank of a hydrogen vehicle at a second demonstration hydrogen energy station in California, with the variable switch point of the present invention. This fill utilizes three storage banks of the cascade storage system.

As can be seen in FIG. 7, the fill rate (bottom line) begins with storage bank 1. When the valve to storage bank 1 is opened flow ramps to a peak value and decreases as it approaches the variable switch point. When the valve to storage bank 2 is opened flow begins at a peak value and decreases as it approaches the variable switch point (1.35 kg/min in this example). When the valve to storage bank 3 is opened flow begins at a peak value and decreases as it approaches the end of the fill (1.71 kg/min in this example). The average fill rate for the fill shown in FIG. 7 was 2.02 kg/min. This is a marked improvement compared to the fill in FIG. 6 which had an average overall fill rate of 1.28 kg/min. The variable switch point of the present invention improved the average flow rate of gaseous hydrogen in the cascade storage system.

While the methods of this invention have been described in terms of preferred or illustrative embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

What is claimed is:

1. A gaseous hydrogen fueling method comprising:
utilizing a cascade storage system containing gaseous hydrogen wherein said cascade storage system comprises a plurality of storage vessels within a plurality of storage banks;
fueling a vehicle tank of a hydrogen vehicle with said gaseous hydrogen from said cascade storage system;
switching between said plurality of storage banks during fueling when a variable switch point is reached; and
stopping fueling when said vehicle tank of said hydrogen vehicle is filled with said gaseous hydrogen.

2. The method of claim 1 further comprising
determining capacity of said cascade storage system;
determining current mass of said gaseous hydrogen in said cascade storage system;
calculating percent of inventory of gaseous hydrogen remaining in said cascade storage system based on said current mass and said capacity;
calculating said variable switch point (VSP) from an empirical equation wherein said variable switch point is a function of percent of inventory of said gaseous hydrogen in said cascade storage system (% Inventory)
VSP=(a*% Inventory−b)*V
wherein said VSP is in kg/min;
wherein said % Inventory is in %;
wherein said a is a constant in range of 0.000017 to 0.000034;
wherein said b is a constant in range of −0.00095 to −0.0024; and
wherein V is vehicle tank volume in liters.

3. The method of claim 2 wherein said a is in the range of 0.00024 to 0.00026.

4. The method of claim 2 wherein said b is in range of −0.00142 to −0.00171.

5. The method of claim 2 wherein said capacity of said cascade storage system is between 64 and 360 kg of said gaseous hydrogen.

6. The method of claim 2 wherein said capacity of said cascade storage system is 1500 kg of gaseous hydrogen.

7. The method of claim 2 wherein said vehicle tank volume is between 152 and 2100 liters.

8. The method of claim 1 wherein said variable switch point is greater than 2 kg/min when said cascade storage system is at capacity and volume of said vehicle tank is at least 2100 liters.

9. The method of claim 1 wherein said variable switch point is between 2.0 kg/min and 0.05 kg/min.

10. The method of claim 1 wherein said hydrogen vehicle is a hydrogen car.

11. The method of claim 1 wherein said hydrogen vehicle is a hydrogen bus.

12. The method of claim 1 wherein said plurality of storage banks comprises three storage banks.

13. The method of claim 1 wherein said plurality of storage banks comprises four storage banks.

14. The method of claim 1 wherein said plurality of storage banks comprises five storage banks.

15. The method of claim 1 wherein said plurality of storage banks comprises six storage banks.

16. The method of claim 1 wherein said plurality of storage banks comprises seven storage banks.

17. The method of claim 1 wherein said plurality of storage banks comprises eight storage banks.

18. The method of claim 1 wherein said plurality of storage banks comprises nine storage banks.
